(19) United States
(12) Patent Application Publication
(10) Pub. No.: US 2026/0155087 A1
(43) Pub. Date: Jun. 4, 2026

(54) DISPLAY APPARATUS AND CONTROL METHOD THEREOF

(71) Applicant: Tianma Advanced Display Technology Institute (Xiamen) Co.,Ltd., Xiamen (CN)

(72) Inventors: Peixuan CHEN, Xiamen (CN); Rutao CHEN, Xiamen (CN)

(21) Appl. No.: 19/057,029

(22) Filed: Feb. 19, 2025

(30) Foreign Application Priority Data
Nov. 29, 2024 (CN) 202411744769.4

(51) Int. Cl. G09G 3/32

(52) U.S. Cl. CPC G09G 3/32; G09G 2320/0242; G09G 2320/041; G09G 2320/0666; G09G 2320/0673; G09G 2330/045

(57) ABSTRACT

The present disclosure provides a display apparatus and a control method of the display apparatus. The display apparatus includes a display panel; at least one temperature sensor, configured to sense a temperature of the display panel; a thermal interaction module, on a backlight side of the display panel; and a control module, electrically connected to the thermal interaction module, where the control module is configured to control the thermal interaction module to perform temperature adjustment on the display panel according to the temperature of the display panel.

### CROSS-REFERENCE TO RELATED APPLICATION

The present disclosure claims the priority of Chinese Patent Application No. 202411744769.4, filed on Nov. 29, 2024, the content of which is incorporated herein by reference in its entirety.

### TECHNICAL FIELD

The present disclosure generally relates to the field of display panel technology and, more particularly, relates to a display apparatus and a control method thereof.

### BACKGROUND

In actual use, display panels may be easily affected by temperature to have color shift (deviation or cast). Taking Micro-LED (micro light-emitting diode) display as an example, as the ambient temperature changes, the white balance and gamma calibrated at room temperature may deviate from design indicators at higher or lower temperatures, which may cause the display panel to have color shift. One of the main reasons for color shift is that the luminance (brightness) and chromaticity of the light-emitting chip of the display panel change with temperature differently, which may cause the white balance and gamma calibrated at room temperature to deviate at high or low temperatures, thereby affecting actual display effect.

### SUMMARY

One aspect of the present disclosure provides a display apparatus. The display apparatus includes a display panel; at least one temperature sensor, configured to sense a temperature of the display panel; a thermal interaction module, on a backlight side of the display panel; and a control module, electrically connected to the thermal interaction module, where the control module is configured to control the thermal interaction module to perform temperature adjustment on the display panel according to the temperature of the display panel.

Another aspect of the present disclosure provides a control method of a display apparatus. The display apparatus includes a display panel; at least one temperature sensor, configured to sense a temperature of the display panel; a thermal interaction module, on a backlight side of the display panel; and a control module, electrically connected to the thermal interaction module, where the control module is configured to control the thermal interaction module to perform temperature adjustment on the display panel according to the temperature of the display panel. The method includes obtaining the temperature of the display panel; and according to the temperature of the display panel, controlling the thermal interaction module to adjust the temperature of the display panel.

Other aspects of the present disclosure may be understood by those skilled in the art in light of the description, the claims, and the drawings of the present disclosure.

### BRIEF DESCRIPTION OF THE DRAWINGS

The accompanying drawings, which are incorporated into a part of the specification, illustrate embodiments of the present disclosure and together with the description to explain the principles of the present disclosure.

To clearly explain embodiments of the present disclosure or the technical solutions in the existing technology, the drawings required for describing embodiments or the existing technology are briefly introduced hereinafter. Obviously, the drawings in the following description are merely embodiments of the present disclosure. Other drawings may also be obtained by those skilled in the art without any creative work according to provided drawings.

FIG. 1 illustrates a structural schematic of a display apparatus according to various embodiments of the present disclosure.

FIG. 2 illustrates another structural schematic of a display apparatus according to various embodiments of the present disclosure.

FIG. 3 illustrates a partial top view of temperature sensor arrangement according to various embodiments of the present disclosure.

FIG. 4 illustrates another structural schematic of a display apparatus according to various embodiments of the present disclosure.

FIG. 5 illustrates another structural schematic of a display apparatus according to various embodiments of the present disclosure.

FIG. 6 illustrates another structural schematic of a display apparatus according to various embodiments of the present disclosure.

FIG. 7 illustrates another structural schematic of a display apparatus according to various embodiments of the present disclosure.

FIG. 8 illustrates another structural schematic of a display apparatus according to various embodiments of the present disclosure.

FIG. 9 illustrates another structural schematic of a display apparatus according to various embodiments of the present disclosure.

FIG. 10 illustrates another partial top view of temperature sensor arrangement according to various embodiments of the present disclosure.

FIG. 11 illustrates another partial top view of temperature sensor arrangement according to various embodiments of the present disclosure.

FIG. 12 illustrates another partial top view of temperature sensor arrangement according to various embodiments of the present disclosure.

FIG. 13 illustrates another structural schematic of a display apparatus according to various embodiments of the present disclosure.

FIG. 14 illustrates another structural schematic of a display apparatus according to various embodiments of the present disclosure.

FIG. 15 illustrates another structural schematic of a display apparatus according to various embodiments of the present disclosure.

FIG. 16 illustrates a flowchart of a control method of a display apparatus according to various embodiments of the present disclosure.

FIG. 17 illustrates another flowchart of a control method of a display apparatus according to various embodiments of the present disclosure.

FIG. 18 illustrates another flowchart of a control method of a display apparatus according to various embodiments of the present disclosure.

FIG. 19 illustrates another flowchart of a control method of a display apparatus according to various embodiments of the present disclosure.

### DETAILED DESCRIPTION

To clearly understand above-mentioned objectives, features and advantages of the present disclosure, the solutions of the present disclosure are further described hereinafter. It should be noted that embodiments of the present disclosure and the features in embodiments may be combined with each other if there is no conflict.

Specific details are described in the following description to facilitate thorough understanding of the present disclosure, but the disclosure may also be implemented otherwise than as described herein. Obviously, embodiments in the description are only some of embodiments of the present disclosure, but not all embodiments.

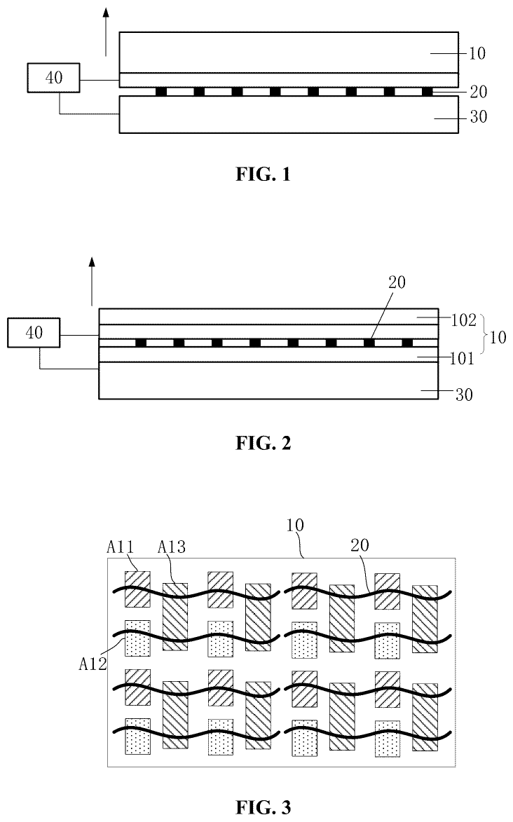

A display apparatus is provided in embodiments of the present disclosure. FIG. 1 illustrates a structural schematic of a display apparatus according to various embodiments of the present disclosure. Referring to FIG. 1, the display apparatus may include a display panel 10; at least one temperature sensor 20, configured to sense the temperature of the display panel 10; a thermal interaction module 30 on the backlight side of the display panel; and a control module 40, where the control module 40 may be electrically connected to the thermal interaction module 30 and configured to control the thermal interaction module 30 to adjust the temperature of the display panel 10 according to the temperature of the display panel 10.

Exemplarily, the display apparatus may include the display panel 10, and at least one temperature sensor 20 may be disposed for sensing the temperature of the display panel. Exemplarily, 8 temperature sensors 20 may be illustrated in FIG. 1. In other embodiments, other numbers of temperature sensors may be disposed, which may be selected according to actual needs. The temperature sensor may be a metal wire. Since the resistance of the metal wire changes with temperature, the temperature corresponding to current metal wire may be determined by detecting the resistance change of the metal wire, thereby realizing the temperature detection of the position where the metal wire is located. For example, a temperature detector circuit board may also be disposed to obtain the resistance of the metal wire. The display panel may have color shift as the ambient temperature changes. For example, the white balance and gamma values calibrated in normal temperature environment may deviate from the indicators during the design test at higher or lower temperatures. Therefore, in embodiments of the present disclosure, the thermal interaction module 30 and the control module 40 may be disposed; and the thermal interaction module 30 may be electrically connected to the control module 40. The thermal interaction module 30 may be disposed on the backlight side of the display panel, such that the thermal interaction module 30 may thermally interact with the display panel 10, and the temperature of the display panel 10 may be adjusted, which may not affect normal light emission of the display panel 10.

For example, the temperature sensor 20 may sense the temperature of the display panel 10 in real time and send the temperature to the control module 40. When the temperature of the display panel 10 is relatively high or low and exceeds a preset stable temperature range due to the influence of the environment or its own light emission, it may consider that the display panel 10 may be more likely to have color shift at this moment. Therefore, the control module 40 may control the thermal interaction module 30 to adjust the temperature of the display panel 10 according to the temperature of the display panel 10, which may adjust the temperature of the display panel 10 to within the preset stable temperature range and reduce the color shift problem caused by the temperature change of the display panel 10. When the thermal interaction module 30 adjusts the temperature of the display panel 10, the display panel 10 may be heated or dissipated (or cooled) according to actual situation. For example, when the temperature of the display panel 10 is higher than the preset stable temperature range, the control module 40 may control the thermal interaction module 30 to dissipate heat or cool to reduce the temperature of the display panel 10; and when the temperature of the display panel is lower than the preset stable temperature range, the control module 40 may control the thermal interaction module 30 to heat to increase the temperature of the display panel 10, thereby achieving the adjustment of different temperature conditions. Therefore, the color shift of the display panel caused by the influence of the ambient temperature change or the temperature change caused by the self-light-emission may be reduced, and the display effect of the display panel may be improved.

The display apparatus provided by the present disclosure may be disposed with at least one temperature sensor for sensing the temperature of the display panel. The thermal interaction module may be also disposed for adjusting the temperature of the display panel. When the temperature of the display panel is detected to be too high or too low and exceed the preset stable temperature range, it may consider that current temperature may cause the display panel to have color shift. At this point, to avoid such problem, the control module may control the thermal interaction module to adjust the temperature of the display panel according to the temperature of the display panel detected by the temperature sensor, such that the temperature of the display panel may be controlled within the preset stable range to reduce the color shift problem caused by the temperature change to the display panel.

It should be noted that the display panel in the display apparatus may be a Micro-LED, and the light effect of a Micro-LED may be more sensitive to temperature, such that the display effect may be easily affected by temperature. In other embodiments, the display panel may also be an OLED (organic light-emitting diode) or the like, which may also be affected by temperature. Therefore, the technical solutions provided by embodiments of the present disclosure may also solve the color shift problem caused by temperature.

Optionally, gamma compensation may be configured to adjust the chromaticity and luminance (brightness) of the display panel, and the display panel may be driven according to the gamma curve corresponding to the temperature of the display panel. That is, when the display panel is at a different temperature, the gamma curve corresponding to such temperature may be configured to drive the display panel.

Taking the display panel as the Micro-LED display as an example, the gamma curve may be set according to the standard that the chromaticity and luminance change of the display panel ΔEab <1, and a gamma curve may be set at an interval of about 1 degree. However, the quantity of gamma curves that may be stored in the driver chip may be limited, for example, about 15. If the temperature change range of −40° C. to 85° C. is considered, one gamma curve may correspond to a temperature change range of ˜8°C. The larger temperature interval may easily cause the human eye to recognize the change in luminance and chromaticity of the display panel during gamma compensation. Therefore, based on the sensitivity of Micro-LED light effect to temperature and the limitation of storage space of gamma curves, it may easily cause luminance and chromaticity jitter of the pictures when Micro-LED performs color shift compensation, which may affect the visual perception. However, in embodiments of the present disclosure, the temperature of the display panel may be sensed by the temperature sensor. If the temperature of the display panel is too high or too low, the control module may control the thermal interaction module to adjust the temperature of the display panel according to the temperature of the display panel detected by the temperature sensor, such that the temperature of the display panel may be controlled within the preset stable temperature range. In such preset stable temperature range, the temperature interval of the set gamma curve may be relatively small. The gamma curve corresponding to the temperature of the display panel may be configured to drive the display panel, and there may be no changes in the luminance and chromaticity of the display panel that may be recognized by the human eye, which may avoid the jitter of display panel pictures during gamma compensation.

In some embodiments, FIG. 2 illustrates another structural schematic of a display apparatus according to various embodiments of the present disclosure. Referring to FIG. 2, the temperature sensor 20 may be integrated in the display panel 10.

Exemplarily, the temperature sensor 20 may be integrated into the display panel 10, and the temperature sensor 20 may be closer to the display panel 10, such that the temperature change inside the display panel 10 may be accurately and directly sensed, actual temperature of the display panel 10 may be obtained, which may reduce the interference of external environment temperature on the sensing process of the temperature sensor 20. Furthermore, the temperature may be transmitted to the control module 40, and the control module 40 may control the thermal interaction module 30 to adjust the temperature of the display panel 10. Furthermore, integrating the temperature sensor 20 inside the display panel 10 may also effectively reduce overall thickness of the display apparatus, which may be beneficial for thin and light design of the display apparatus.

It should be noted that multiple film layers and circuit structures may be included inside the display panel 10. The positions and quantity of the temperature sensors 20 may be not limited in embodiments of the present disclosure, which may be set according to actual needs.

In some embodiments, referring to FIG. 2, the temperature sensor 20 may be between the driver circuit layer 102 and the substrate 101 of the display panel 10.

For example, the temperature sensor 20 may be disposed between the driver circuit layer 102 and the substrate 101 of the display panel 10. For example, a metal film layer may be disposed between the driver circuit layer 102 and the substrate 101; and a metal wire may be made through the metal film layer to obtain the temperature sensor 20. The length, width and material of the metal wire may be not limited in embodiments of the present disclosure, which may be set according to actual needs. The metal wire may be used as the temperature sensor 20. When the temperature of the display panel 10 changes, the resistance of the metal wire may change accordingly. The resistance of the metal wire may be obtained by the detection device to determine the temperature of the display panel 10.

Therefore, for embodiments of the present disclosure, it may not only accurately and directly sense the temperature change inside the display panel 10, obtain actual temperature of the display panel 10 and reduce the interference of external environment temperature on the sensing process of the temperature sensor 20, but also effectively reduce the thickness of the display apparatus as a whole, which may be beneficial for the thin and light design of the display apparatus.

In some embodiments, FIG. 3 illustrates a partial top view of temperature sensor arrangement according to various embodiments of the present disclosure. Referring to FIG. 3, the temperature sensor 20 may be configured in a curved wire shape and at least partially overlapped with a plurality of pixels of different colors of the display panel 10.

Exemplarily, embodiments of the present disclosure provide partial pixels in the display panel, such as a plurality of red pixels A11, green pixels A12 and blue pixels A13; and the pixels of different colors may be arranged in an array in the display panel. The temperature sensor 20 may be integrated in the display panel 10 and configured in a curved wire shape and may be overlapped with the pixels of different colors of the display panel 10. The overlapping between the temperature sensor and the pixels of different colors may uniformly detect the temperature of different pixel positions. The area of a single pixel may be limited, and the degree of resistance change may be limited, which may be not beneficial for temperature detection. The temperature sensor 20 may be overlapped with the plurality of pixels of different colors, which may increase the length and the resistance value of the temperature sensor 20. The resistance value change may be more obvious after the temperature changes, which may be beneficial for subsequent detection of different temperatures. Furthermore, two ends of the temperature sensor with the curved wire shape may be led out to the lower edge of the display panel 10 through metal leads, and the resistance change may be measured through the temperature detector circuit board.

It should be noted that the drawings provided in embodiments of the present disclosure may be only optional implementation manners for showing the overlapping relationship between the temperature sensor with the curved wire shape and the pixels. The curved wire shape of actual temperature sensor and the area of the pixel may be set according to actual needs. For example, actual temperature sensor may be configured as a grid wire, a W-shaped wire or the like; and the distance between different temperature sensors may also be selected according to actual needs, which may not be limited in embodiments of the present disclosure. Furthermore, the temperature sensor may also use other types of devices for temperature detection instead of metal wires.

In some embodiments, referring to FIG. 1, the temperature sensor 20 may be disposed at the backlight side of the display panel 10.

Exemplarily, as shown in FIG. 1, the arrow direction may be the light-emitting direction of the display panel 10, and the side away from the light-emitting direction may be the backlight side of the display panel 10. The temperature sensor 20 may be disposed on the backlight side of the display panel 10, which may not only sense the temperature of the display panel 10 but also avoid the temperature sensor 20 blocking the light emission of the display panel 10 to affect the light-emitting effect of the display panel 10. Furthermore, disposing the temperature sensor 20 outside the display panel 10 may not affect original panel structure and process technology of the display panel 10 and may simplify overall design.

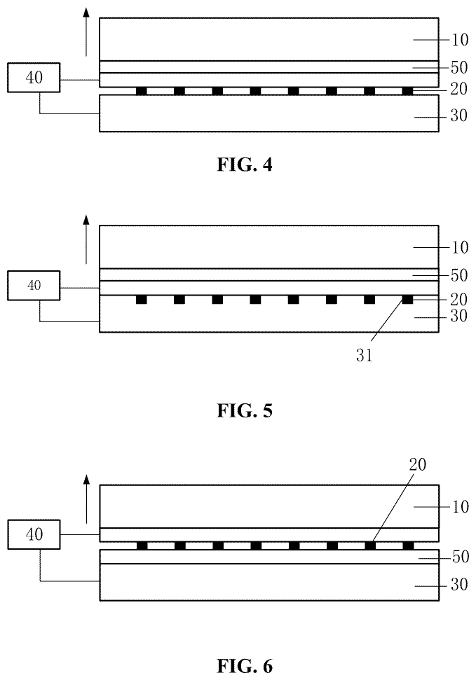

In some embodiments, FIG. 4 illustrates another structural schematic of a display apparatus according to various embodiments of the present disclosure. Referring to FIG. 4, a heat equalizing layer 50 may be disposed between the display panel 10 and the thermal interaction module 30.

During the display process of the display panel 10, the patterns displayed at different positions may be different, and the luminance at different positions may also be different. The temperature of the region with relatively high luminance may be higher than the temperature of the region with relatively low luminance, which may lead to temperature differences at various positions in entire display panel; and overall temperature of the display panel may be uneven to cause different degrees of color shift, which may result in uneven luminance and chromaticity of the display panel. In subsequent adjustment process, there may be a situation that the color shift of a certain region may be adjusted, but the color shift of another region cannot be solved or greater. Therefore, to avoid above situation, in embodiments of the present disclosure, the heat equalizing layer 50 may be disposed. The heat equalizing layer 50 may be disposed between the display panel 10 and the thermal interaction module 30. The temperature of each position of the display panel 10 may be uniform to be at same temperature level through the heat equalizing layer 50, which may avoid uneven temperature of the display panel 10 to affect subsequent adjustment of the color shift of entire display panel. Furthermore, the heat equalizing layer 50 may be disposed between the display panel 10 and the thermal interaction module 30, which may not affect original panel structure and process technology of the display panel 10. The heat equalizing layer 50 may be selected as a metal plate, such as copper foil, aluminum plate, VC plate (steam chamber) or the like, which may be selected according to actual needs and attached to needed position.

In some embodiments, referring to FIG. 4, the temperature sensor 20 may be between the heat equalizing layer 50 and the thermal interaction module 30.

Exemplarily, the temperature sensor 20 may be disposed between the heat equalizing layer 50 and the thermal interaction module 30. When the thermal interaction module 30 adjusts the temperature of the display panel 10, it needs to uniformly adjust the temperature of the display panel 10 through the heat equalizing layer 50. For example, when the temperature sensor 20 senses that the temperature of the display panel 10 is too low, it needs to use the thermal interaction module 30 to heat the display panel 10. The thermal interaction module 30 may transfer heat to the heat equalizing layer 50, and the heat equalizing layer 50 may uniformly heat various regions of the display panel 10.

In some embodiments, FIG. 5 illustrates another structural schematic of a display apparatus according to various embodiments of the present disclosure. Referring to FIG. 5, the thermal interaction module 30 may be disposed with a first groove structure 31, and the temperature sensor 20 may be in the first groove structure 31.

Exemplarily, the thermal interaction module 30 may be disposed with the first groove structure 31. The temperature sensor 20 may be disposed in the first groove structure 31 to effectively reduce entire thickness of the display apparatus, which may be beneficial for the thin and light design of the display apparatus. The quantity of the first groove structures 31 may have a one-to-one correspondence with the quantity of the temperature sensors 20; and corresponding structures may also have a one-to-one correspondence with to each other, such that the temperature sensors 20 may be inserted in the first groove structures 31. The first groove structure 31 illustrated in FIG. 5 may be understood as a cross-sectional view. From the perspective of the top view, the first groove structure 31 may have same shape as the temperature sensor 20. “Same” herein may be “same within a certain range”.

In some embodiments, FIG. 6 illustrates another structural schematic of a display apparatus according to various embodiments of the present disclosure. Referring to FIG. 6, the temperature sensor 20 may be between the heat equalizing layer 50 and the display panel 10.

Exemplarily, to more accurately obtain the temperature of the display panel 10, the temperature sensor 20 may be disposed between the heat equalizing layer 50 and the display panel 10. The temperature sensor 20 may be closer to the display panel 10, which may improve the accuracy of sensing the temperature. Furthermore, the temperature sensor 20 and the thermal interaction module 30 may be separated by the heat equalizing layer 50, which may reduce the influence of the temperature of the thermal interaction module 30 on the sensing process of the temperature sensor 20, further improve the accuracy of sensing the temperature of the display panel 10 and avoid the detection error caused by instantaneous temperature change of the thermal interaction module 30.

In some embodiments, FIG. 7 illustrates another structural schematic of a display apparatus according to various embodiments of the present disclosure. Referring to FIG. 7, the heat equalizing layer 50 may be disposed with a second groove structure 51, and the temperature sensor 20 may be in the second groove structure 51.

Exemplarily, the heat equalizing layer 50 may be disposed with the second groove structure 51. The temperature sensor 20 may be disposed in the second groove structure 51 to effectively reduce the thickness of entire display apparatus, which may be beneficial for the thin and light design of the display apparatus. Furthermore, the distance between the heat equalizing layer 50 and the display panel 10 may be reduced, and the heat equalizing layer 50 may desirably contact the display panel to avoid affecting the heat-spreading effect. The quantity of the second groove structures 51 may have a one-to-one correspondence with the quantity of the temperature sensors 20; and corresponding structures may also have a one-to-one correspondence with each other, such that the temperature sensors 20 may be inserted in the second groove structures 51. The second groove structure 51 provided in FIG. 7 may be understood as a cross-sectional view. In the top view angle, the second groove structure 51 may have same shape as the temperature sensor 20. “Same” herein may be “same within a certain range”.

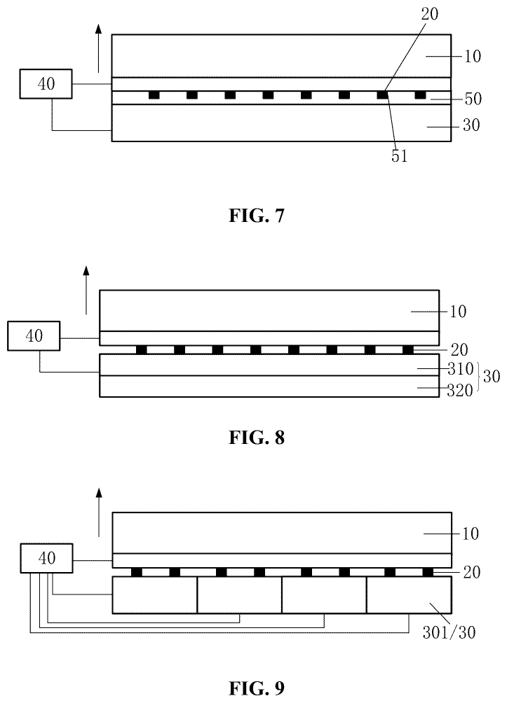

In some embodiments, FIG. 8 illustrates another structural schematic of a display apparatus according to various embodiments of the present disclosure. Referring to FIG. 8, the thermal interaction module 30 may include a heating module 310 and a heat dissipating module 320; and the heat dissipating module 320 may be on the side of the heating module 310 away from the display panel 10.

In embodiments of the present disclosure, the thermal interaction module 30 may adjust the temperature of the display panel 10; and the temperature adjustment may include heating the display panel to increase temperature and dissipating or cooling the display panel to reduce temperature. Therefore, the thermal interaction module 30 may include the heating module 310 and the heat dissipating module 320. The heat dissipating module 320 may be on the side of the heating module 310 away from the display panel 10, such that the heat dissipating module 320 may dissipate the heat of the display panel 10 to external environment, which may prevent the heat from being retained in the display apparatus to affect the temperature of the display panel 10.

For example, when the temperature sensor 20 senses that the temperature of the display panel 10 is too high, the control module 40 may control the heat dissipating module 320 to start and cool the display panel 10. When the temperature sensor 20 senses that the temperature of the display panel is too low, the control module may control the heating module 310 to start to heat the display module.

Optionally, the heating module and the heat dissipating module may be same module, for example, a metal wire. When the temperature of the display panel is relatively low, the metal wire may be heated to increase the temperature of the metal wire, and the metal wire may provide heat to the display panel to heat up the display panel. When the temperature of the display panel is relatively high, the metal wire may also transfer the temperature of the display panel to itself and dissipate the heat to the outside to achieve the purpose of cooling.

In some embodiments, referring to FIG. 8, the heat dissipating module 320 may include a cooling portion and/or a heat dissipating fin portion.

Exemplarily, when the heat dissipating module 320 dissipates heat for the display panel, there may be two different operation manners. One manner may be an active heat dissipating manner, and another manner may be a passive heat dissipating manner; and the start timing of two heat dissipating manners may be different. For example, in the active heat dissipating manner, a temperature range may need to be pre-set. When the temperature sensor 20 senses that the temperature of the display panel 10 exceeds the pre-set temperature range, the heat dissipating module 320 may cool down the display panel 10. In the passive heat dissipating manner, the heat dissipating module 320 may continue to dissipate heat without subsequent operations based on current temperature of the display panel 10. Therefore, the heat dissipating module 320 may include the cooling portion, which may belong to the active heat dissipating manner, and the timing of starting the cooling portion may be determined according to the temperature of the display panel 10. Or the heat dissipating module 320 may include the heat dissipating fin portion, which may belong to the passive heat dissipating manner. The heat dissipating fin portion may be directly attached to desired position and may absorb the heat of the display panel 10 and dissipate the heat without control. The heat dissipating effect may be related to the area of the heat dissipating fin portion. Therefore, the heat dissipating module 320 may include at least one of the cooling portion and the heat dissipating fin portion to dissipate the heat of the display panel 10, and the combination of above portions may further improve the heat dissipating effect.

In some embodiments, referring to FIG. 8, the cooling portion may include a semiconductor cooling plate.

In embodiments of the present disclosure, the cooling portion may include the semiconductor cooling plate which may be a cooling device including semiconductors. When direct current passes through a diode formed by two different semiconductor materials in series, heat may be absorbed and released at two ends of the diode, thereby achieving the purpose of cooling. Two different semiconductor materials may P-type semiconductors and N-type semiconductors. External leads of the semiconductor cooling plate may have positive and negative polarities. Changing the direction of current may change the heat absorbing surface and the heat dissipating surface of the semiconductor cooling plate. The semiconductor cooling plate may not require any refrigerant and have no pollution source; work continuously and have a long service life; and may have no vibration or noise during operation. Furthermore, the semiconductor cooling plate may achieve high-precision temperature control under current control and have relatively wide temperature adjustment range, which may be beneficial for temperature adjustment of the display panel 10.

In some embodiments, referring to FIG. 8, the heat dissipating fin portion may be on the side of the cooling portion away from the display panel.

The temperature of the side of the cooling portion adjacent to the display panel may be relatively low which may cool the display panel 10, while the temperature of the side of the cooling portion away from the display panel may be relatively high. Therefore, in embodiments of the present disclosure, the heat dissipating fin portion may be disposed on the side of the cooling portion away from the display panel; and the heat dissipating fin portion may also cool the side of the cooling portion with relatively high temperature, which may reduce the temperature of entire display apparatus.

In some embodiments, the thermal interaction module may include an air duct structure; and the air duct structure may be connected to the air duct of the vehicle air conditioner.

For example, the display screen in the vehicle may be greatly affected by the ambient temperature, so that the display panel may be easily affected by the temperature to have color shift. Therefore, the display apparatus provided by embodiments of the present disclosure may be applied to the vehicle as the display screen of the vehicle, which may reduce the influence of external ambient temperature.

When the thermal interaction module in the display apparatus adjusts the temperature of the display panel, the thermal interaction module may both increase and decrease the temperature of the display panel. When the display apparatus provided by embodiments of the present disclosure is disposed in the vehicle, the thermal interaction module may also include the air duct structure; and the air duct structure may be connected to the air duct of the vehicle air conditioner. By controlling the temperature increase or decrease of the vehicle air conditioner, the purpose of controlling the heating or cooling (heat dissipating) of the thermal interaction module may be achieved. For example, when the temperature of the display panel is too high, the air duct of the air conditioner may be configured to transfer hot air to the air duct structure of the thermal interaction module, such that the thermal interaction module may increase the temperature of the display panel. In the vehicle, the temperature of the display panel may be adjusted by using existing air conditioning structure of the vehicle, which may simplify overall structure of the display panel.

In some embodiments, FIG. 9 illustrates another structural schematic of a display apparatus according to various embodiments of the present disclosure. Referring to FIG. 9, the display apparatus may include the plurality of temperature sensors 20; the thermal interaction module 30 may include the plurality of thermal interaction submodules 301, and at least one temperature sensor 20 may be disposed at a region corresponding to each thermal interaction submodule; and the plurality of thermal interaction submodules 301 may be electrically connected to the control module 40.

In embodiments of the present disclosure, the thermal interaction module 30 may include the plurality of thermal interaction submodules 301; at least one temperature sensor 20 may be disposed at a region corresponding to each thermal interaction submodule; and the temperature sensor 20 in the region may be configured to sense the temperature of the display panel 10 in corresponding region. When the temperature sensor 20 in a certain region sense that the temperature of the display panel is relatively high or low, the control module 40 may control the thermal interaction submodule 301 in corresponding region to adjust the temperature of the display panel 10.

For example, FIG. 9 shows only a partial structure of the display apparatus. Taking four thermal interaction submodules 301 as an example, each thermal interaction submodule 301 may be electrically connected to the control module 40, and two temperature sensors may be disposed in corresponding region of each thermal interaction submodule 301 to sense the temperature of the display panel 10 in corresponding region. If the temperature sensor 20 in corresponding region of the first thermal interaction submodule 301 senses that the temperature of the display panel 10 in such region is relatively high, while the temperature of the display panel 10 in other three regions is stable, there may be no need to adjust the temperature of entire display panel 10. The control module 40 may control the first thermal interaction submodule 301 to dissipate heat in such region of the display panel 10, which may reduce the temperature of the display panel 10 in such region and realize regionalized local control of the display panel. If the temperature sensor 20 in the region corresponding to the second thermal interaction submodule 301 senses that the temperature of the region of the display panel 10 is relatively high, and if the temperature sensor 20 in the region corresponding to the fourth thermal interaction submodule 301 senses that the temperature of the region of the display panel 10 is relatively low, at this point, the control module 40 may control the second thermal interaction submodule 301 to dissipate heat from corresponding region of the display panel 10, and control the fourth thermal interaction submodule 301 to heat corresponding region of the display panel 10. Therefore, the display panel may be divided into a plurality of regions, and the temperatures of different regions may be adjusted respectively, which may not only achieve accurate adjustment of the temperatures of different regions of the display panel 10 but also reduce overall power consumption.

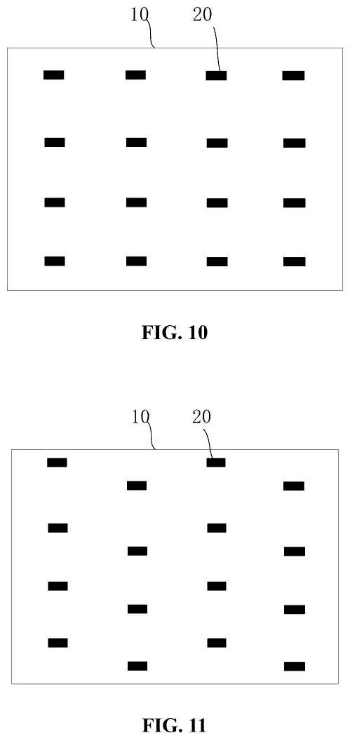

In some embodiments, FIG. 10 illustrates another partial top view of temperature sensor arrangement according to various embodiments of the present disclosure. Referring to FIG. 10, the display panel 10 may include the plurality of temperature sensors 20 which may be evenly distributed on the display panel 10.

Exemplarily, as shown in FIG. 10, a partial structure in the display apparatus is provided in embodiments of the present disclosure, which may illustrate some temperature sensors 20. The display panel 10 may include the plurality of temperature sensors 20, which may be evenly distributed on the display panel 10, such that the temperatures of different regions of the display panel 10 may be fully sensed, which may avoid missing certain regions. The structures, the quantity and the placement positions of the temperature sensors 20 may be set according to actual needs, and the spacing between adjacent temperature sensors 20 may be not limited in embodiments of the present disclosure. The temperature sensor 20 may be inside or outside the display panel 10. The drawings may only show the overlapping between the temperature sensor 20 and the display panel 10, which may not indicate specific film layer order.

Furthermore, FIG. 10 may only show a feasible manner of uniformly distributing temperature sensors; and adjacent rows/columns of the temperature sensors may be arranged to be staggered with each other or the like. For example, referring to FIG. 11, FIG. 11 illustrates another partial top view of temperature sensor arrangement according to various embodiments of the present disclosure; and all temperature sensors 20 may be evenly arranged to be staggered with each other.

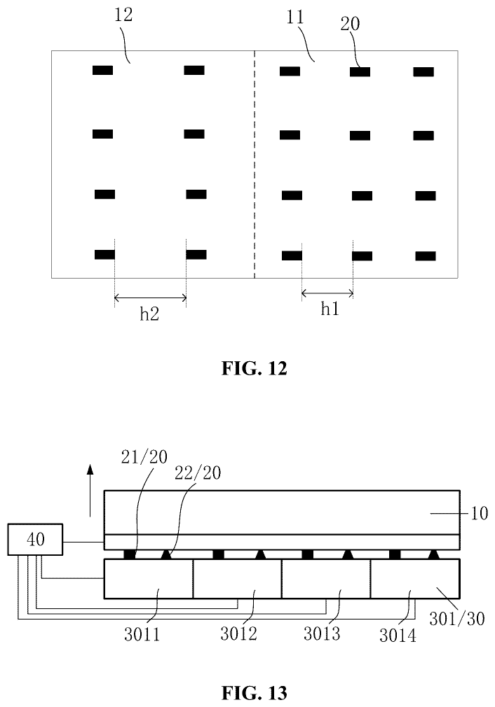

In some embodiments, FIG. 12 illustrates another partial top view of temperature sensor arrangement according to various embodiments of the present disclosure. Referring to FIG. 12, the display apparatus may include the plurality of temperature sensors 20; the display apparatus may include the first region 11 and the second region 12; and the density of the temperature sensors 20 arranged in the first region 11 may be greater than the density of the temperature sensors 20 arranged in the second region 12.

Exemplarily, the display apparatus may include the first region 11 and the second region 12. When disposing the temperature sensors, the temperature sensors 20 may be configured differently according to the needs of different regions. For example, more temperature sensors 20 may be disposed for regions with relatively large temperature changes or relatively large heat generation in the display panel 10, such that the temperature conditions of various positions in the region may be more accurately sensed. Less temperature sensors 20 may be disposed for regions with relatively small temperature changes or relatively small heat generation in the display panel to save costs. Therefore, the display apparatus may be divided into the first region 11 and the second region 12; and the density of the temperature sensors 20 arranged in the first region 11 may be greater than the density of the temperature sensors 20 arranged in the second region 12. Taking the vehicle display screen as an example, the region where the main display screen is located may be the center of the display screen, the heat generated in such region may be relatively large, and the display panel 10 may be more susceptible to temperature, such that such region may be the first region 11, and the density and quantity of disposed temperature sensors 20 may be relatively large. However, the edge of the vehicle display screen may not display excess content, and the heat generated in such region may be relatively small, such that such region may be the second region 12, and the density and quantity of the temperature sensors disposed may be relatively small.

It should be noted that the division of the first region and the second region of the display apparatus may be not limited in embodiments of the present disclosure, and above-mentioned embodiment may be only an optional implementation manner. The purpose of embodiments of the present disclosure may be to configure the quantity of temperature sensors differently according to actual needs of different regions.

In some embodiments, referring to FIG. 12, the distance h1 between adjacent temperature sensors 20 in the first region 11 may be less than the distance h2 between adjacent temperature sensors 20 in the second region 12.

For example, the distance between adjacent temperature sensors in the first region 11 may be h1, the distance between adjacent temperature sensors 20 in the second region 12 may be h2, and h1<h2. Therefore, when the region areas of the first region 11 and the second region 12 are same, more temperature sensors 20 may be disposed in the first region 11, and less temperature sensors 20 may be disposed in the second region 12, such that the density of the temperature sensors 20 arranged in the first region 11 may be greater than the density of the temperature sensors 20 arranged in the second region 12; and the differentiated design of the temperature sensors 20 in the first region 11 and the second region 12 may be realized.

In some embodiments, FIG. 13 illustrates another structural schematic of a display apparatus according to various embodiments of the present disclosure. Referring to FIG. 13, at least one first-type temperature sensor 21 and at least one second-type temperature sensor 22 may be disposed in corresponding region of the thermal interaction submodule 301.

The control module 40 may be configured to control the second-type temperature sensor 22, corresponding to same thermal interaction submodule 301 as the first-type temperature sensor 21, to obtain the temperature of the display panel 10 based on that the difference in detected temperatures of the first-type temperature sensors 21 in corresponding regions of different thermal interaction submodules 301 is greater than a temperature difference threshold.

Exemplarily, to avoid errors in the process of sensing the temperature of the display panel which may affect subsequent adjustment of the color shift of the display panel, at least one first-type temperature sensor 21 and at least one second-type temperature sensor 22 may be disposed in corresponding position range of the thermal interaction submodule 301 in embodiments of the present disclosure. FIG. 13 exemplarily provides four thermal interaction submodules 301, that is, the first thermal interaction submodule 3011, the second thermal interaction submodule 3012, the third thermal interaction submodule 3013 and the fourth thermal interaction submodule 3014. Each thermal interaction submodule 301 may be disposed with one first-type temperature sensor 21 and one second-type temperature sensor 22 in corresponding position range. The quantity of disposed temperature sensors may be selected according to actual needs, which may be exemplarily described in embodiments of the present disclosure.

For example, when sensing the temperature of the display panel 10, the first-type temperature sensor 21 may be first configured to sense the display panel 10. If detected temperature difference between the first-type temperature sensors 21 in corresponding regions of different thermal interaction submodules 301 is greater than the temperature difference threshold, in order to avoid the first-type temperature sensors 21 having detection deviation, the control module 40 may control the second-type temperature sensor 22, corresponding to same thermal interaction submodule 301 as the first-type temperature sensor 21, to obtain the temperature of the display panel 10. For example, the first-type temperature sensors 21 in corresponding regions of the first thermal interaction submodule 3011 to the fourth thermal interaction submodule 3014 may sense the temperatures of the display panel 10 in corresponding regions, and may obtain temperatures T1, T2, T3 and T4 respectively. If the temperature difference between temperature T1 and temperature T4 is greater than the temperature difference threshold, it may reasonably suspect that there are problems with the first-type temperature sensor 21 in the region corresponding to the first thermal interaction submodule 3011 and the first-type temperature sensor 21 in the region corresponding to the second thermal interaction submodule 3014, which may result in relatively large temperature error. Therefore, the control module 40 may control the second-type temperature sensor 22 in the region corresponding to the first thermal interaction submodule 3011 and the second-type temperature sensor 22 in the region corresponding to the second thermal interaction submodule 3014 to obtain the temperatures of the display panel 10; and the temperature T1′ and the temperature T4′ may be obtained to determine whether the detection data of the first-type temperature sensors 21 is accurate.

Therefore, the second-type temperature sensors 22 may not need to be started for a long time; and may only need to start the second-type temperature sensors 22 when detected temperature difference of the first-type temperature sensors 21 in corresponding regions of different thermal interaction submodules 301 is greater than the temperature difference threshold, which may reduce the power consumption of the second-type temperature sensors 22 to a certain extent and avoid deviations in temperature detection. The first-type temperature sensor 21 and the second-type temperature sensor 22 may be only configured to distinguish main functions of two types of temperature sensors and may not represent two types of temperature sensors. The first-type temperature sensor 21 may be mainly configured to sense temperature, and the second-type temperature sensor 22 may be mainly configured to verify temperature.

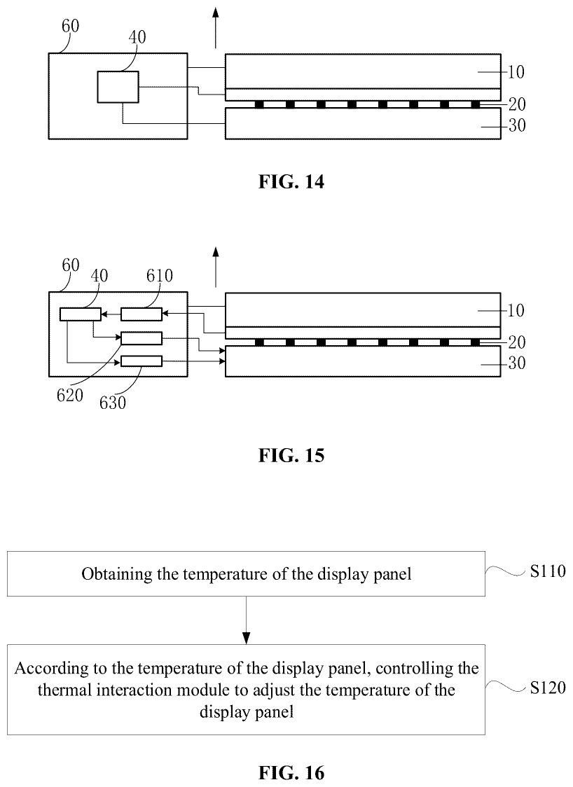

In some embodiments, FIG. 14 illustrates another structural schematic of a display apparatus according to various embodiments of the present disclosure. Referring to FIG. 14, the display apparatus may further include a display driver circuit board 60 which may be electrically connected to the display panel 10; and the control module 40 may be integrated on the display driver circuit board 60.

In embodiments of the present disclosure, the display apparatus may include the display driver circuit board 60 which may be electrically connected to the display panel 10. The display driver circuit board 60 may include various driver circuits to drive the display panel 10 to emit light. Optionally, the control module 40 may be integrated on the display driver circuit board 60, which may reduce the occupation of the hardware structure on the display apparatus space and reduce the volume of the display apparatus. The positional relationship between the display driver circuit board 60 and the display panel 10 may be set according to actual needs. FIG. 14 may be only a block diagram to illustrate included modules and may not represent actual positional relationship between the display driver circuit board 60 and the display panel 10.

For example, FIG. 15 illustrates another structural schematic of a display apparatus according to various embodiments of the present disclosure. Referring to FIG. 15, the display apparatus may also include a multi-channel temperature conversion module 610, a heating power module 620 and a cooling power module 630. The temperature sensor 20 may be electrically connected to the control module 40 through the multi-channel temperature conversion module 610; the thermal interaction module 30 may include the heating module and the heat dissipating module (not shown in FIG. 15) ; the heating module may be electrically connected to the control module 40 through the heating power module 620; and the heat dissipating module may be electrically connected to the control module 40 through the cooling power module 630. The multi-channel temperature conversion module 610 may transmit the temperature obtained by the temperature sensor 20 to the control module 40; and the control module 40 may control the heating power module 620 to be in conduction and start the heating module according to actual temperature of the display panel, or may control the cooling power module 630 to be in conduction and start the heat dissipating module to adjust the temperature of the display panel 10. Above-mentioned modules may also be integrated into the display driver circuit board 60 or may be configured as discrete structures, which may not be limited in embodiments of the present disclosure.

In some embodiments, the control module may be reused as a controller of a vehicle infotainment system.

When the display apparatus provided by embodiments of the present disclosure is disposed in a vehicle, the controller of the vehicle infotainment system may be reused as the control module of the display apparatus. When the display apparatus is used as the vehicle display screen, the display apparatus may mainly display the status of the vehicle, and the user may control relevant functions and parameters of the vehicle through the display apparatus, which may all need to be controlled by the controller of the vehicle infotainment system. Therefore, the controller of the vehicle infotainment system may also be configured to control the thermal interaction module in the display apparatus to adjust the temperature of the display panel. When the temperature sensor senses the temperature of the display panel and transmits the temperature to the controller of the vehicle infotainment system, the controller of the vehicle infotainment system may determine the temperature change of the display panel, and determine whether the thermal interaction module is controlled to adjust the temperature of the display panel, and how the temperature of the display panel is adjusted, which may not only meet the requirements of adjusting the temperature of the display panel and reduce the color shift of the display panel but also reduce hardware structures and costs.

Embodiments of the present disclosure also provide a control method of the display apparatus, which may be applicable to any of above-mentioned display apparatuses. FIG. 16 illustrates a flowchart of a control method of a display apparatus according to various embodiments of the present disclosure. Referring to FIG. 16, the control method may include S110-S120.

At S110, the temperature of the display panel may be obtained.

The temperature of the display panel may be affected by the ambient temperature and its own light emission. For example, when the ambient temperature rises, the temperature of the display panel may also rise, and when the ambient temperature drops, the temperature of the display panel may also drop; or when the luminance of the display panel is too high, the temperature may also rise. Furthermore, the white balance and gamma of the display panel calibrated at normal temperature may deviate from the display standard at higher or lower temperatures, which may result in color shift of the display panel. To avoid the color shift of the display panel, the temperature of the display panel may be obtained, and how to reduce the color shift of the display panel may be determined according to the temperature change of the display panel. For example, at least one temperature sensor may be disposed in the display apparatus, and the temperature of the display panel may be sensed in real time by the temperature sensor to obtain the temperature change of the display panel.

At S120, according to the temperature of the display panel, the thermal interaction module may be controlled to adjust the temperature of the display panel.

When the display panel is affected by the environment or its own light emission to have a high or low temperature which exceeds the preset stable temperature range, it may consider that current display panel may be easily to have color shift. Therefore, according to the temperature of the display panel, the thermal interaction module may be controlled to adjust the temperature of the display panel, adjust the temperature of the display panel to within the preset stable temperature range, and reduce the color shift problem caused by the temperature change of the display panel. When the thermal interaction module adjusts the temperature of the display panel, the display panel may be heated or cooled according to actual conditions. For example, if the temperature of the display panel is too high, the thermal interaction module may be controlled to dissipate heat or cool to reduce the temperature of the display panel; and if the temperature of the display panel is too low, the thermal interaction module may be controlled to heat to increase the temperature of the display panel, thereby achieving adjustment of different temperature conditions and reducing the color shift caused by the temperature of the display panel.

In some embodiments, controlling the thermal interaction module to adjust the temperature of the display panel according to the temperature of the display panel may include, according to the temperature of the display panel being greater than or equal to the first preset temperature threshold, controlling the thermal interaction module to dissipate heat from the display panel; or according to the temperature of the display panel being less than or equal to the second preset temperature threshold, controlling the thermal interaction module to heat the display panel, where the first preset temperature threshold may be greater than the second preset temperature threshold.

For example, the first preset temperature threshold and the second preset temperature threshold may be configured, and the first preset temperature threshold may be greater than the second preset temperature threshold. When the thermal interaction module adjusts the temperature of the display module, it needs to obtain the temperature of the display panel. When the temperature of the display panel is greater than or equal to the first preset temperature threshold, it may consider that current temperature of the display panel is too high, and the color shift may be easily to occur. At this point, the thermal interaction module may be controlled to dissipate heat from (cool) the display panel to reduce the temperature of the display panel, thereby reducing the possibility of color shift. When the temperature of the display panel is less than or equal to the second preset temperature threshold, it may consider that current temperature of the display panel is too low, and the color shift may be also easily to occur. The thermal interaction module may be controlled to heat the display panel to increase the temperature of the display panel, thereby reducing the possibility of color shift. In such way, the color shift of the display panel due to the change of ambient temperature or the temperature change caused by its own light emission may be reduced, and the display effect of the display panel may be improved.

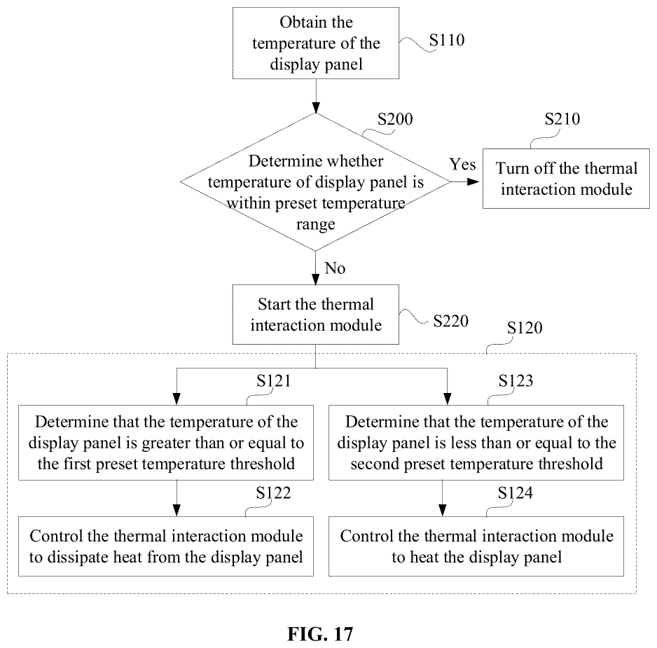

For example, FIG. 17 illustrates another flowchart of a control method of a display apparatus according to various embodiments of the present disclosure. Referring to FIG. 17, the first preset temperature threshold and the second preset temperature threshold may be configured, and the control method of the display apparatus may include following exemplary steps.

At S110, the temperature of the display panel may be obtained.

At S200, whether the temperature of the display panel is within the preset temperature range may be determined; if yes, execute S210, otherwise execute S220.

At S210, the thermal interaction module may be turned off.

At S220, the thermal interaction module may be started.

At S121, it may determine that the temperature of the display panel is greater than or equal to the first preset temperature threshold.

At S122, the thermal interaction module may be controlled to dissipate heat from the display panel.

At S123, it may determine that the temperature of the display panel is less than or equal to the second preset temperature threshold.

At S124, the thermal interaction module may be controlled to heat the display panel.

The first preset temperature threshold may be greater than the second preset temperature threshold.

In some embodiments, the first preset temperature threshold may be 60 degrees, and the second preset temperature threshold may be 20 degrees.

Exemplarily, when the temperature of the display panel is higher than 60 degrees, it may consider that the temperature of the display panel may be too high, the color deviation may be likely to occur, and the thermal interaction module may need to be controlled to dissipate heat from (cool) the display panel; and when the temperature of the display panel is lower than 20 degrees, it may consider that the temperature of the display panel may be too low, the color deviation may be likely to occur, and the thermal interaction module may need to be controlled to heat the display panel. That is, when the temperature of the display panel is between 20 degrees and 60 degrees, there may be no need to control the display panel, the display panel may adjust the chromaticity and luminance by itself, and the possibility of color deviation may be relatively low.

It should be noted that the above may be only a feasible temperature threshold provided by embodiments of the present disclosure, and other temperatures may also be selected as the first preset temperature threshold and the second preset temperature threshold according to actual needs. In embodiments of the present disclosure, external environment temperature and the temperature of the display panel itself caused by the light emission may be considered, and the temperature range of the display panel that does not need to be adjusted may be configured to between 20 degrees and 60 degrees. Setting such relatively wide range may avoid frequent adjustment of the temperature of the display panel. For example, if the temperature range is set at 20 degrees to 30 degrees, the display panel may easily reach the temperature threshold. When in high temperature weather, it needs to frequently control the thermal interaction module to cool the display panel, which may affect the use effect of the display apparatus. However, setting normal temperature range at 20 degrees to 30 degrees may not be excluded in embodiments of the present disclosure, and actual application scenario may also need to be considered, which may be configured according to actual needs.

In some embodiments, the method may also include that based on the temperature of the display panel being greater than the second preset temperature threshold and less than the first preset temperature threshold, the display panel may be driven according to the gamma curve corresponding to the temperature of the display panel.

Exemplarily, when the temperature of the display panel is between the second preset temperature threshold and the first preset temperature threshold, it may indicate that the temperature of current display panel may meet the surface temperature of the display panel during normal operation which is set during the design process of the display panel. If the temperature of the display panel changes, the luminance and chromaticity of the display panel may deviate due to the influence of temperature. At this point, the display panel may be driven according to the gamma curve corresponding to the temperature of the display panel, and the color shift caused by the small temperature change of the display panel may be compensated by the gamma curve. In embodiments of the present disclosure, the temperature of the display panel may be limited between the second preset temperature threshold and the first preset temperature threshold, and a plurality of gamma curves may be stored in the register of the driver chip, and the stored gamma curves may compensate for the color shift caused by the temperature change of the display panel when the temperature of the display panel is within this range. The gamma curve corresponding to the temperature of the display panel may be a gamma curve obtained by testing under normal temperature when the display panel is pre-designed.

In some embodiments, the chroma-luminance difference between adjacent gamma curves corresponding to the display panel may satisfy ΔEab<1.

Exemplarily, the gamma curve may be configured to compensate for the chromaticity and luminance deviation of the display panel caused by temperature changes. When configuring the gamma curves, the chroma-luminance difference of the display panel corresponding to adjacent gamma curves should satisfy ΔEab<1. When adjacent gamma curves are within such range, the temperature of the display panel may change by about 1 degree, and the temperature interval may be relatively small. When different gamma curves are configured to drive the display panel, the driving current of the light-emitting element in the display panel may change slightly, such that the luminance of the light-emitting element may change slightly and cannot be recognized by the human eye. In such way, the changes in luminance and chromaticity may be controlled within a range that is not recognizable to the human eye, which may avoid the jitter of the display panel picture when the gamma curves are configured for compensation. It should be noted that the gamma curves may be pre-stored in the register of the driver chip, and the storage location may be selected according to actual needs.

In some embodiments, before obtaining the temperature of the display panel, the method may include determining to obtain any one of a vehicle starting signal, a door opening signal, a key sensing signal, an air conditioner starting signal, and a preset time.

The display apparatus provided by embodiments of the present disclosure may be used in a vehicle as the display screen of the vehicle. The display screen of the vehicle may be more susceptible to the influence of external ambient temperature. In combination with actual application scenario, the temperature sensor may be pre-started to adjust the temperature of the display panel in advance before the user uses the display panel, which may improve the color shift of the display panel, thereby reducing the waiting time of the user.

For example, it may determine that the vehicle starting signal is obtained, and the display panel may also start after the vehicle is started. To avoid the color shift after the display panel is turned on, the temperature of the display panel may be obtained, and the display panel may be adjusted in advance. Optionally, it may determine that the door opening signal or the key sensing signal is obtained, which may indicate that the user is approaching the vehicle and about to start the vehicle. After the vehicle is started, the display panel may also operate. To avoid the color shift after the display panel is turned on, the temperature of the display panel may be obtained, and the display panel may be adjusted in advance. Optionally, it may determine that the air conditioner starting signal is obtained, which may indicate that current ambient temperature needs to be adjusted, and the ambient temperature may directly affect the temperature of the display panel. To avoid the color shift of the display panel due to the ambient temperature, the temperature of the display panel may be obtained. Or the display panel may be sensed in advance; and when a preset time is reached, the temperature of the display panel may be obtained to determine whether the temperature of the display panel needs to be adjusted.

It should be noted that the temperature of the display panel may be obtained if any one of above-mentioned conditions is satisfied, and above-mentioned signals may be sent by the vehicle infotainment system to the control module, and the temperature sensor module may be started by the control module. Above-mentioned manners may be all for detecting the temperature of the display panel in advance and adjusting the temperature of the display panel when the user uses the display panel, which may avoid the temperature of the display panel being affected by the ambient temperature or the light emission of the display panel itself, and further avoid obvious color shift of the screen when the display panel is started.

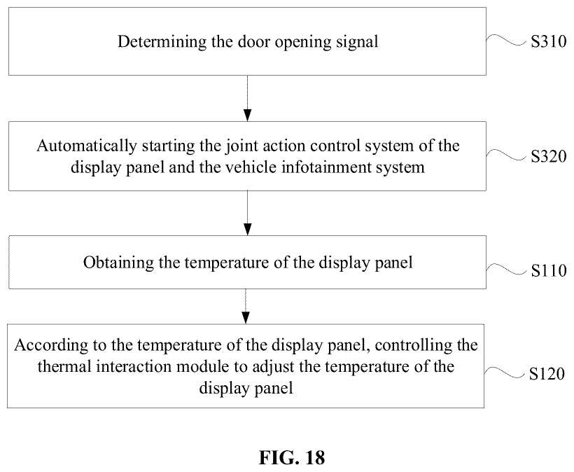

Exemplarily, FIG. 18 illustrates another flowchart of a control method of a display apparatus according to various embodiments of the present disclosure. Referring to FIG. 18, taking the determination of the door opening signal as an example, the control method may include following exemplary steps.

At S310, the door opening signal may be determined.

At S320, the joint action control system of the display panel and the vehicle infotainment system may be automatically started.

At S110, the temperature of the display panel may be obtained.

At S120, according to the temperature of the display panel, the thermal interaction module may be controlled to adjust the temperature of the display panel.

When the user opens the door, the vehicle infotainment system may determine the door opening signal, the joint action control system of the vehicle infotainment system and the display panel may be started, and the vehicle computer may send the control signal to the control module of the display panel to start the temperature sensor. Furthermore, the temperature of the display panel may be obtained, and the thermal interaction module may be controlled to adjust the temperature of the display panel and stabilize the temperature of the display panel according to the temperature of the display panel, which may avoid obvious color shift of the display panel when the display panel is turned on to be used due to excessively high or low ambient temperature.

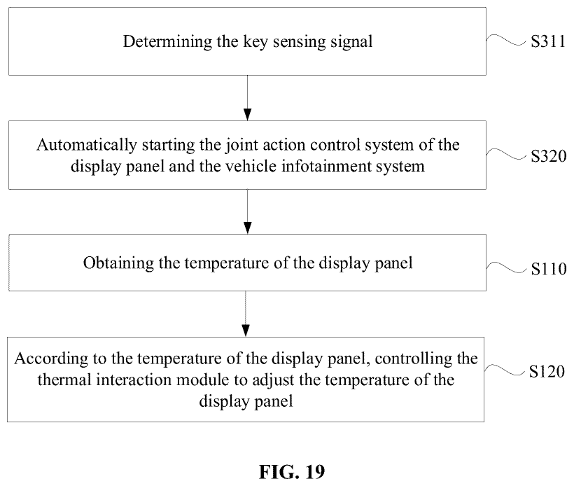

FIG. 19 illustrates another flowchart of a control method of a display apparatus according to various embodiments of the present disclosure. Referring to FIG. 19, taking determining the key sensing signal as an example, the control method may include following exemplary steps.

At S311, the key sensing signal may be determined.

At S320, the joint action control system of the display panel and the vehicle infotainment system may be automatically started.

At S110, the temperature of the display panel may be obtained.

At S120, according to the temperature of the display panel, the thermal interaction module may be controlled to adjust the temperature of the display panel.

When the user approaches the vehicle, the vehicle infotainment system may determine the key signal, the joint action control system of the vehicle infotainment system and the display panel may be started, and the vehicle infotainment system may send the control signal to the control module of the display panel to start the temperature sensor. Furthermore, the temperature of the display panel may be obtained, and the thermal interaction module may be controlled to adjust the temperature of the display panel and stabilize the temperature of the display panel according to the temperature of the display panel, which may avoid obvious color shift of the display panel when the display panel is turned on to be used due to excessively high or low ambient temperature.

In some embodiments, the display apparatus may include the plurality of temperature sensors; the thermal interaction module may include the plurality of thermal interaction submodules, and at least one temperature sensor may be disposed at the region corresponding to each thermal interaction submodule; and the plurality of thermal interaction submodules may be electrically connected to the control module.

According to the temperature of the display panel, controlling the thermal interaction module to adjust the temperature of the display panel may include, according to the temperature detected by the temperature sensor at the region corresponding to the thermal interaction submodule, controlling the thermal interaction submodule to adjust the temperature of the display panel.

Exemplarily, the display apparatus may include the plurality of temperature sensors, the thermal interaction module may also include the plurality of thermal interaction submodules, at least one temperature sensor may be disposed at the region corresponding to each thermal interaction submodule, and the temperature sensor in such region may be configured to sense the temperature of the display panel in corresponding region. When the temperature sensor in a certain region sense that the temperature of the display panel is relatively high or low, the control module may control the thermal interaction submodule in corresponding region to adjust the temperature of the display panel.

For example, referring to FIG. 9, if the temperature sensor 20 in corresponding region of the first thermal interaction submodule 301 senses that the temperature of the display panel 10 in such region is relatively high, while the temperature of the display panel 10 in other three regions is stable, there may be no need to adjust the temperature of entire display panel 10. The control module 40 may control the first thermal interaction submodule 301 to dissipate heat in such region of the display panel 10, which may reduce the temperature of the display panel 10 in such region and realize regionalized local control of the display panel. If the temperature sensor 20 in the region corresponding to the second thermal interaction submodule 301 senses that the temperature of the region of the display panel 10 is relatively high, and if the temperature sensor 20 in the region corresponding to the fourth thermal interaction submodule 301 senses that the temperature of the region of the display panel 10 is relatively low, at this point, the control module 40 may control the second thermal interaction submodule 301 to dissipate heat from corresponding region of the display panel 10, and control the fourth thermal interaction submodule 301 to heat corresponding region of the display panel 10. Therefore, the display panel may be divided into a plurality of regions, and the temperatures of different regions may be adjusted respectively, which may not only achieve accurate adjustment of the temperatures of different regions of the display panel 10 but also reduce overall power consumption.

In some embodiments, at least one first-type temperature sensor and at least one second-type temperature sensor may be disposed in corresponding region of the thermal interaction submodule.

Obtaining the temperature of the display panel may include obtaining the detected temperature of the first-type temperature sensor in corresponding region of each thermal interaction submodule; and based on that detected temperature difference of the first-type temperature sensors in corresponding regions of different thermal interaction submodules is greater than the temperature difference threshold, controlling the second-type temperature sensor corresponding to same thermal interaction submodule as the first-type temperature sensor to obtain the temperature of the display panel.

Exemplarily, when sensing the temperature of the display panel, the first-type temperature sensor may be first configured to sense the display panel to obtain detected temperature of the first-type temperature sensor in corresponding region of each thermal interaction submodule. If detected temperature difference of the first-type temperature sensors in corresponding regions of different thermal interaction submodules is greater than the temperature difference threshold, to avoid the first-type temperature sensor to have detection deviation, the second-type temperature sensor corresponding to same thermal interaction submodule as the first-type temperature sensor may be controlled to obtain the temperature of the display panel.

For example, referring to FIG. 13, the first-type temperature sensors 21 in corresponding regions of the first thermal interaction submodule 3011 to the fourth thermal interaction submodule 3014 may sense the temperatures of the display panel 10 in corresponding regions, and may obtain temperatures T1, T2, T3 and T4 respectively. If the temperature difference between temperature T1 and temperature T4 is greater than the temperature difference threshold, it may reasonably suspect that there are problems with the first-type temperature sensor 21 in the region corresponding to the first thermal interaction submodule 3011 and the first-type temperature sensor 21 in the region corresponding to the second thermal interaction submodule 3014, which may result in relatively large temperature error. Therefore, the control module 40 may control the second-type temperature sensor 22 in the region corresponding to the first thermal interaction submodule 3011 and the second-type temperature sensor 22 in the region corresponding to the second thermal interaction submodule 3014 to obtain the temperatures of the display panel 10; and the temperature T1′ and the temperature T4′ may be obtained to determine whether the detection data of the first-type temperature sensors 21 is accurate.

Therefore, the second-type temperature sensors may not need to be started for a long time; and may only need to start the second-type temperature sensors when detected temperature difference of the first-type temperature sensors in corresponding regions of different thermal interaction submodules is greater than the temperature difference threshold, which may reduce the power consumption of the second-type temperature sensors 22 to a certain extent and avoid deviations in temperature detection. The first-type temperature sensor and the second-type temperature sensor may be only configured to distinguish main functions of two types of temperature sensors and may not represent two types of temperature sensors. The first-type temperature sensor may be mainly configured to sense temperature, and the second-type temperature sensor may be mainly configured to verify temperature.

It may be seen from above-mentioned embodiments that the present disclosure may at least achieve following beneficial effects.

The display apparatus provided by the present disclosure may be disposed with at least one temperature sensor for sensing the temperature of the display panel. The thermal interaction module may be also disposed for adjusting the temperature of the display panel. When the temperature of the display panel is detected to be too high or too low and exceed the preset stable temperature range, it may consider that current temperature may cause the display panel to have color shift. At this point, to avoid such problem, the control module may control the thermal interaction module to adjust the temperature of the display panel according to the temperature of the display panel detected by the temperature sensor, such that the temperature of the display panel may be controlled within the preset stable range to reduce the color shift problem caused by the temperature change to the display panel.

It should be noted that in the present disclosure, relational terms such as “first” and “second” may be only configured to distinguish one entity or operation from another entity or operation and may not necessarily require or imply that such actual relationship or order is between these entities or operations. Furthermore, the terms “comprise”, “include” or any other variations thereof may be intended to cover a non-exclusive inclusion. Therefore, a process, a method, an article or apparatus including a set of elements may include not only those elements, but also other elements not expressly listed, or also include elements inherent in the process, the method, the article or apparatus. Without further limitations, an element defined by the statement “include a . . . ” may not exclude the presence of additional identical elements in the process, the method, the article, or apparatus including such element.

The above may be merely embodiments of the present disclosure, which may make those skilled in the art to understand or implement the present disclosure. Various modifications to embodiments of the present disclosure may be apparent to those skilled in the art. General principles defined in the present disclosure may be implemented in other embodiments without departing from the spirit or scope of the present disclosure. Therefore, the present disclosure may not be limited to embodiments described in the present disclosure but may be accorded the widest scope consistent with the principles and novel features of the present disclosure.

What is claimed is

1. A display apparatus, comprising:
a display panel;
at least one temperature sensor, configured to sense a temperature of the display panel;
a thermal interaction module, on a backlight side of the display panel; and
a control module, electrically connected to the thermal interaction module, wherein the control module is configured to control the thermal interaction module to perform temperature adjustment on the display panel according to the temperature of the display panel.

2. The display apparatus according to claim 1, wherein:
the at least one temperature sensor is between a driver circuit layer and a substrate of the display panel.

3. The display apparatus according to claim 1, wherein:
the at least one temperature sensor is in a curved wire shape and at least overlapped with a plurality of pixels of different colors of the display panel.

4. The display apparatus according to claim 1, wherein:
a heat equalizing layer is disposed between the display panel and the thermal interaction module; or
the at least one temperature sensor is between a heat equalizing layer and the display panel.

5. The display apparatus according to claim 4, wherein:
the at least one temperature sensor is between the heat equalizing layer and the thermal interaction module; and
the thermal interaction module is disposed with a first groove structure, and a temperature sensor is in the first groove structure.

6. The display apparatus according to claim 4, wherein:
the heat equalizing layer is disposed with a second groove structure, and a temperature sensor is in the second groove structure.

7. The display apparatus according to claim 1, wherein:
the thermal interaction module includes a heating module and a heat dissipating module; and the heat dissipating module is on a side of the heating module away from the display panel.

8. The display apparatus according to claim 7, wherein:
the heat dissipating module includes a cooling portion and/or a heat dissipating fin portion; and
the heat dissipating fin portion is on a side of the cooling portion away from the display panel.

9. The display apparatus according to claim 1, wherein:
the display apparatus includes a plurality of temperature sensors; the thermal interaction module includes a plurality of thermal interaction submodules; at least one temperature sensor is disposed in a region corresponding to each thermal interaction submodule; and the plurality of thermal interaction submodules is electrically connected to the control module.

10. The display apparatus according to claim 1, wherein:
the display apparatus includes a plurality of temperature sensors evenly distributed on the display panel.

11. The display apparatus according to claim 1, wherein:
the display apparatus includes a plurality of temperature sensors; the display apparatus includes a first region and a second region; and a density of temperature sensors disposed in the first region is greater than a density of temperature sensors disposed in the second region.

12. The display apparatus according to claim 11, wherein:
a distance between adjacent temperature sensors in the first region is less than a distance between adjacent temperature sensors in the second region.

13. The display apparatus according to claim 9, wherein:
at least one first-type temperature sensor and at least one second-type temperature sensor are disposed in a region corresponding to a thermal interaction submodule; and
the control module is configured to, based on that a difference in detection temperatures of first-type temperature sensors in regions corresponding to different thermal interaction submodules is greater than a temperature difference threshold, control a second-type temperature sensor, corresponding to a same thermal interaction submodule as a first-type of temperature sensor, to obtain the temperature of the display panel.

14. A control method of a display apparatus, wherein the display apparatus includes a display panel; at least one temperature sensor, configured to sense a temperature of the display panel; a thermal interaction module, on a backlight side of the display panel; and a control module, electrically connected to the thermal interaction module, wherein the control module is configured to control the thermal interaction module to perform temperature adjustment on the display panel according to the temperature of the display panel; the method comprising:
obtaining the temperature of the display panel; and
according to the temperature of the display panel, controlling the thermal interaction module to adjust the temperature of the display panel.

15. The method according to claim 14, wherein according to the temperature of the display panel, controlling the thermal interaction module to adjust the temperature of the display panel includes:
according to the temperature of the display panel being greater than or equal to a first preset temperature threshold, controlling the thermal interaction module to dissipate heat from the display panel; or according to the temperature of the display panel being less than or equal to a second preset temperature threshold, controlling the thermal interaction module to heat the display panel, wherein the first preset temperature threshold is greater than the second preset temperature threshold.

16. The method according to claim 15, wherein:
the first preset temperature threshold is about 60 Celsius degrees, and the second preset temperature threshold is about 20 Celsius degrees.

17. The method according to claim 15, further including:
based on that the temperature of the display panel is greater than the second preset temperature threshold and less than the first preset temperature threshold, driving the display panel according to a gamma curve corresponding to the temperature of the display panel.

18. The method according to claim 17, wherein:
a chroma-luminance difference (ΔEab) of the display panel corresponding to adjacent gamma curves satisfies ΔEab<1.

19. The method according to claim 14, wherein:
the display apparatus includes a plurality of temperature sensors; the thermal interaction module includes a plurality of thermal interaction submodules; at least one temperature sensor is disposed in a region corresponding to each thermal interaction submodule; and the plurality of thermal interaction submodules is electrically connected to the control module; and
controlling the thermal interaction module to adjust the temperature of the display panel according to the temperature of the display panel includes controlling a thermal interaction submodule to adjust the temperature of the display panel according to a temperature detected by a temperature sensor in a region corresponding to the thermal interaction submodule.

20. The method according to claim 19, wherein:
at least one first-type temperature sensor and at least one second-type temperature sensor are disposed in a region corresponding to the thermal interaction submodule; and
obtaining the temperature of the display panel includes obtaining detection temperatures of first-type temperature sensors in regions corresponding to all thermal interaction submodules; and based on that a difference in detection temperatures of first-type temperature sensors in regions corresponding to different thermal interaction submodules is greater than a temperature difference threshold, controlling a second-type temperature sensor, corresponding to a same thermal interaction submodule as a first-type of temperature sensor, to obtain the temperature of the display panel.
